(19) United States
(12) Patent Application Publication
(10) Pub. No.: US 2006/0271579 A1
(43) Pub. Date: Nov. 30, 2006

(54) Storage usage analysis

(76) Inventor: Arun Batish, Portland, OR (US)

Correspondence Address: LIEBERMAN & BRANDSDORFER, LLC, 802 STILL CREEK LANE, GAITHERSBURG, MD, 20878, US

(21) Appl. No.: 11/125,461

(22) Filed: May 10, 2005

(51) Int. Cl. G06F 7/00; G06F 17/00

(52) U.S. Cl. 707/101

(57) ABSTRACT

A process and system are provided to automate identification of storage units in communication with client machines. A tool is invoked to support identification of each client machine in communication with a server, as well as each storage unit in the file system in communication with each identified client machine. The identification information of both the client machines and the storage units is saved in memory. This supports the ability to automate the process of compiling data of each identified client machine with each identified storage unit.

### BACKGROUND OF THE INVENTION

1. Technical Field

This invention relates to management of a file system for a computer. More specifically, the invention relates to automation associated with determining storage availability in the file system.

2. Description of the Prior Art

There are two primary storage management systems for network based storage. One system is known as network attached storage in which storage units are connected to the network through a network connection. Another system is known as a storage area network (SAN) attached storage in which the SAN houses and manages multiple storage units. The SAN is connected to the network through a fiber optic cable. The SAN file system is an example of a software based storage management system that directs client machines to specific storage devices for reading and/or writing data, and is proprietary to International Business Machines Corporation. In both the network attached storage and the SAN, storage units may be accessible by one or more client machines. There are two categories of storage units in the SAN, a physical storage device and a logical storage device. A physical storage device is the entire storage device, such as a RAID controller and its associated disks, a disk drive, a tape drive, etc. A physical storage device is often measured in terabytes and is built from engineering specifications that specify reliability, serviceability, performance, or a specific price per megabyte. A logical storage device is typically built from one or more pieces of a physical storage device. A logical storage device is often measured in megabytes and is created to meet the requirements of a system administrator, such as planning availability, backup policies, disaster recovery, or other high level storage requirements. Storage products, such as the SAN file system organize physical storage units into logical storage units for management of data.

FIG. 1 is a prior art block diagram (10) of a distributed file system including a server cluster (20), a plurality of client machines (12), (14), and (16), and a storage area network (SAN) (30). Each of the client machines communicate with one or more server machines (22), (24), and (26) over a data network (40). Similarly, each of the client machines (12), (14), and (16) and each of the server machines in the server cluster (20) are in communication with the storage area network (30). The storage area network (30) includes a plurality of shared disks (32) and (34) that contain blocks of data for associated files. Similarly, the server machines (22), (24), and (26) contain metadata pertaining to location and attributes of the associated files. Each of the client machines may access an object or multiple objects stored on the file data space of the SAN (30), but may not access the metadata storage. In opening the contents of an existing file object on the storage media in the SAN (30), a client machine contacts one of the server machines to obtain metadata and locks. Metadata supplies the client with information about a file, such as its attributes and location on storage devices. Locks supply the client with privileges it needs to open a file and read or write data. The server machine performs a look-up of metadata information for the requested file within metadata storage of the SAN (30). The server machine communicates granted lock information and file metadata to the requesting client machine, including the location of all data blocks making up the file. Once the client machine holds a lock and knows the data block location(s), the client machine can access the data for the file directly from a shared storage device attached to the SAN (30).

In the distributed file system shown in FIG. 1, each of the client machines are in communication with the SAN (30). Although each of the clients is in communication with the SAN (30), this does not guarantee that each of the clients has access to each storage unit, physical and logical, in the SAN. As noted above, each logical storage unit is comprised of one or more physical storage units. One or more clients may not be able to access each physical storage unit in a specified logical storage unit. The SAN may be configured such that specific storage units may be accessible to some clients in the network and not available to other clients in the network. It is the responsibility of the server machine to monitor availability of storage units in the SAN to the individual client machines in the network.

FIG. 2 is a flow chart (50) of a prior art method for the server to maintain data associated with accessibility of logical storage units by client machines in the network. At a first step, an administrator logs onto a master server, i.e. a cluster leader, of a client-server file system and starts an administrative command line interface (52). The master server is a server machine in the network that manages all of the other servers in the network known as subordinate server nodes. The administrator executes a command that returns a list of all client machines connected to the master server (54). The list returned at step (54) is saved in an output text file (56). For each identified client machine (58), a subsequent command is run on the master server to identify which logical storage units are in communication with the specified client (60). The output of the command run at step (60) is conducted individually for each client machine, and each output of each client machine is saved in a separate text file (62). Thereafter, a test is conducted to determine if there are any client machines in the network that have not been queried to determine associated logical storage units (64). A positive response to the query at step (64) is followed by a return to step (58). However, following a negative response to the query at step (64), a person manually compares the output of each text file generated at step (62) to determine which logical storage units are connected to all of the client machines (66), and which logical storage units are only connected to individual client machines (68). After the comparison at steps (66) and (68), a test is conducted to determine if a new client machine has been added to the network, or if a previously connected client machine has been disconnected from the network (70). A negative response to the test at step (70) will result in a creation of a list of logical storage units available for usage by identified client machines (72). Similarly, a positive response to the test at step (70) will return to step (52) to restart the identification process. Accordingly, the prior art process requires a manual compilation of data identifying availability of logical storage units to client machines.

One of the drawbacks associated with the prior art solution is the time consumption associated with manual compilation. The results from execution of the command line interface are not stored in memory. Rather, they are sent to an output device with a hardcopy generated therefrom. It is therefore desirable to formulate an automated system for compiling the identifying information in a manner that will efficiently utilize system resources without affecting the integrity and operation of the SAN and the client machines.

### SUMMARY OF THE INVENTION

This invention comprises a process and system for automating identification of storage units in communication with client machines.

In one aspect of the invention, a method is provided for managing a storage area network file system. Each storage unit in the file system in communication with each identified client machine is identified, for each client machine in communication with a server. Compilation of data for each identified client machine with each identified storage unit is automated.

In another aspect of the invention, a computer system is provided with a storage area network in communication with a server and a client machine. A storage manager is provided to identify each storage unit in the storage area network in communication with each client machine in communication with the server. In addition, a compiler is provided to automate compilation of data for each identified client machine with each identified storage unit.

In yet another aspect of the invention, an article is provided in a computer-readable signal-bearing medium. Means in the medium are provided for identifying each storage unit in a file system in communication with each client machine in communication with a server and a storage area network file system. Means in the medium are also provided for automating compilation data of each identified client machine with each identified storage unit.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a distributed file system in communication with a storage area network.

FIG. 2 is a prior art flow chart illustrating a method for compiling logical storage unit availability to client machines in the network.

FIGS. 3a and 3b are flow charts illustrating a method for compiling logical storage unit availability to client machines in the network according to the preferred embodiment of this invention, and is suggested for printing on the first page of the issued patent.

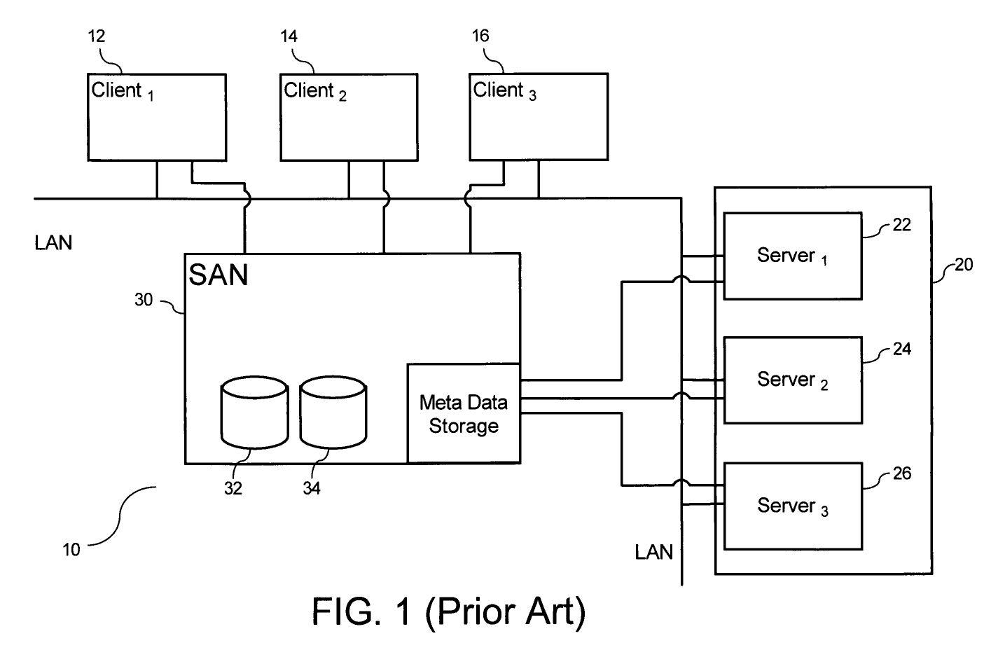

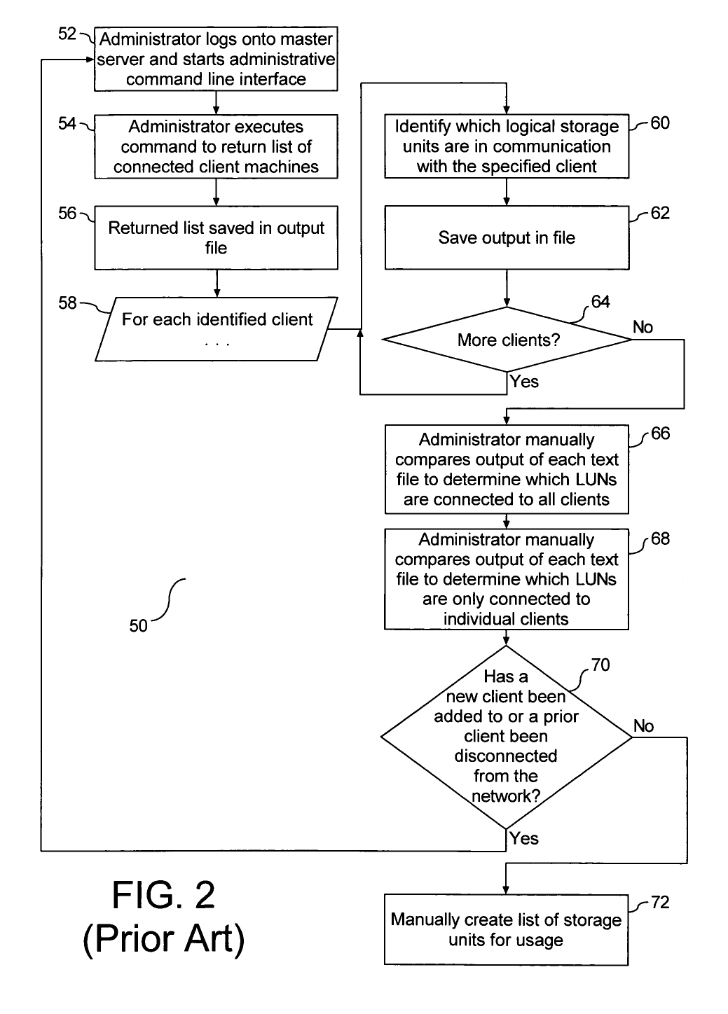

### DESCRIPTION OF THE PREFERRED EMBODIMENT

### Overview

In a client-server network in communication with a SAN, groupings of storage units are gathered into logical storage units. For security or other reasons, it may be that each client machine in the network is not in communication with each logical storage unit. As such, an automated mechanism is provided to identify which client machines are in communication with available logical storage units. The availability of this information ensures that client machines are not attempting to communicate with logical storage units to which they do not have access privileges. Data pertaining to the identification is captured in memory of a server machine. This enables the data to be subsequently parsed or otherwise organized to provide pertinent communication information between the client machines and the logical storage units available to the server machines in the network.

### Technical Details

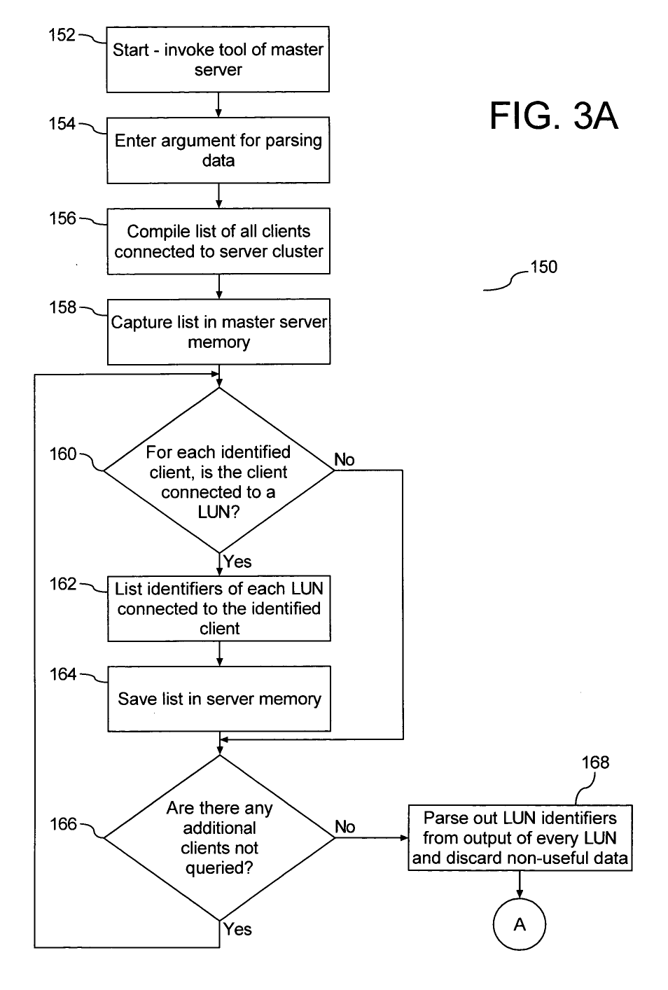

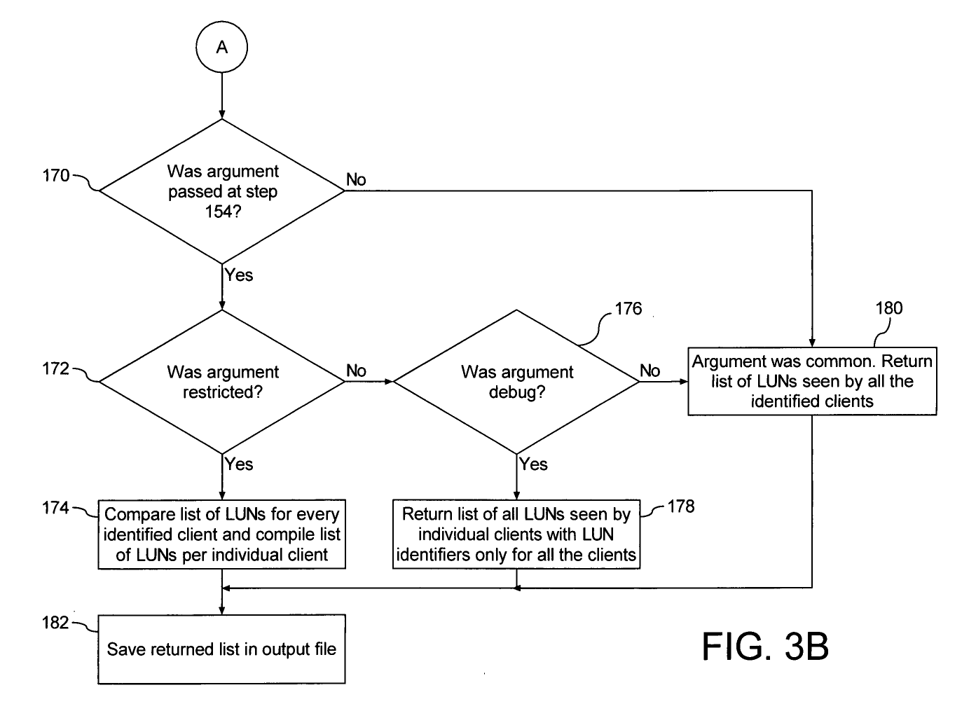

FIG. 3 is a flow chart (150) illustrating a process for automating compilation of file system data in a client-server file system. The process includes invoking a tool in which output is captured in system memory of the master server. An interface is invoked on the master server console (152) which requires an argument to capture and format raw data for presentation to a user (154). In one embodiment, the argument provided may include common, restricted, or debug. A common argument will return data associated with all of the client machines in the system. Similarly, a restricted argument will return data associated with a specified client machine. A debug argument will return data of an individual client machine, for each identified client machine. Prior to the tool parsing the data, a list is compiled to identify each client machine connected to the server cluster in the file system (156). This list is captured in memory of the master server (158).

Accordingly, the initial part of the compilation process includes creating a list of each client machine in communication with the server cluster.

Following identification of the client machines, each identified client machine is queried to determine accessibility of the client machine to logical storage units in the SAN to determine if the identified client machine is connected to a logical storage unit in the SAN (160). A positive response to the test at step (160) results in production of a list of identifiers of each logical storage unit connected to the identified client machine (162), and saving the list in memory of the master server (164). Following completion of the list at step (164) or a negative response to the test at step (160), a test is conducted to determine if there are other identified client machines that have not been queried (166).

A positive response to the test at step (166) will cause a return to step (160) to produce a list of logical storage units connected to the next identified client machine. However, once a list of logical storage units have been identified for each client machine, the identifiers of the logical storage units saved into memory at step (164) are parsed and raw data capture in conjunction with the identifiers are discarded from the generated list with non-useful information being discarded (168). Following step 168, the parsed out logical storage unit identifiers and the number of logical storage units per client remain in server memory. Accordingly, the compilation process includes identifying each logical storage unit in communication with each identified client machine.

Following the identification process at steps (160)-(164) and parsing in step (168), a test is conducted to determine if an argument was passed at step 154 for parsing the compiled data (170). A positive response to the test at step (170) will result in a subsequent test to determine if the passed argument was restricted (172) by comparing an argument value passed at step 154 with a value associated with a restricted argument. If the response to the test at step (172) is positive, the list of logical storage units is parsed to produce a list of logical storage units in communication with a specified client machine (174). However, if the response to the test at step (172) is negative, a test is conducted to determine if the passed argument was debug (176) by comparing an argument value passed at step 154 with a value associated with a debug argument. If the response to the test at step (176) is positive, the list of logical storage units is parsed to produce a list of all logical storage units in communication with an individual client machine for each identified client machine (178). However, if the response to the test at step (172) or step (176) is negative, this is an indication that the intended argument is common. A list of all logical storage units in communication with all of the identified client machines is produced (180). Regardless of the argument used to parse the data associated with identification of the logical storage units in the server memory, the data parsed with the argument at step (174), (178), or (180) is saved in an output file of the server memory (184). Accordingly, the compiled and parsed data may be saved in an output file for use at a later time.

The process and system for compiling access of each client machine to a logical storage unit does not affect resources of the server(s). As such, the tool may be invoked at any time on the master sever. The tool may include a storage manager to identify storage units, a client manager to identify and manage the client machines, and a compiler to automate compilation data of each identified client machine. In one embodiment, the storage manager may be stored on a computer-readable medium as it contains data in a machine readable format. Similarly, the compiler used to compile date for each identified client machine may also be embedded in a machine readable format to automate the compilation process, and the client manager may also be embedded in machine readable format. Accordingly, the client manager, the storage manager, and the compiler may all be in the form of hardware elements in the computer system or software elements in a computer-readable format or a combination of software and hardware.

### Advantages Over The Prior Art

The tool automates parsing of data relevant to the user and saving the parsed data in memory. Different argument values may be passed to the data to compile parsed and formatted data relevant to the user. Compilation of data may be conducted in the memory and does not require manual review of hardcopy data. By saving the output in memory, use of the output can be processed efficiently. In addition, the tool may be invoked at any time without affecting use of the system resources.

### Alternative Embodiments

It will be appreciated that, although specific embodiments of the invention have been described herein for purposes of illustration, various modifications may be made without departing from the spirit and scope of the invention. In particular, the tool may be invoked in a distributed file system or any client-server file system utilizing a SAN or network attached storage. Furthermore, the tool may be invoked on a command line interface, a graphical user interface, or an alternative interface which supports output of the generated data being saved in memory. Accordingly, the scope of protection of this invention is limited only by the following claims and their equivalents.

We claim:

1. A method for managing a storage area network file system comprising:
for each client in communication with a server, identifying each storage unit in said file system in communication with each identified client machine; and
automating compilation of data for each identified client machine with each identified storage unit.

2. The method of claim 1, further comprising parsing said compiled data with a first type argument to return a list of all storage units in communication with all identified client machines.

3. The method of claim 1, further comprising parsing said compiled data with a second type argument to return a list of storage units in communication with a specified client machine.

4. The method of claim 1, further comprising parsing said compiled date with a third type argument to return a list of all storage units in communication with an individual client machine for each identified client machine.

5. The method of claim 1, wherein the step of identifying each client and each logical storage unit is executed on a master server.

6. A computer system comprising:
a storage area network in communication with a server and a client machine;
a storage manager adapted to identify each storage unit in said storage area network in communication with each client machine in communication with said server; and
a compiler adapted to automate compilation of data for each identified client machine with each identified storage unit.

7. The system of claim 6, further comprising an argument adapted to parse said compiled data.

8. The system of claim 7, wherein a first type argument is adapted to return a list of all storage units in communication with all identified client machines.

9. The system of claim 7, wherein a second type argument is adapted to return a list storage units in communication with a specified client machine.

10. The system of claim 7, wherein a third type argument is adapted to return a list of all storage units in communication with an individual client machine for each identified client machine.

11. An article comprising:
a computer-readable signal-bearing medium;
means in the medium for identifying each storage unit in said file system in communication with each client machine in communication a server and a storage area network file system; and
means in the medium for automating compilation data of each identified client machine with each identified storage unit.

12. The article of claim 11, wherein said medium is selected from a group consisting of: a recordable data storage medium, and a modulated carrier signal.

13. The article of claim 11, further comprising means in the medium for parsing said compiled data with a first type argument to return a list of all storage units in communication with all identified client machines.

14. The article of claim 11, further comprising means in the medium for parsing said compiled data with a second type argument to return a list of storage units in communication with a specified client machine.

15. The article of claim 11, further comprising means in the medium for parsing said compiled date with a third type argument to return a list of all storage units in communication with an individual client machine for each identified client machine.

16. The article of claim 11, wherein the means for identifying each client and each logical storage unit is executed on a master server.
